(19) United States
(12) Patent Application Publication
(10) Pub. No.: US 2015/0310391 A1
(43) Pub. Date: Oct. 29, 2015

(54) MANAGING VOTING EMAILS

(71) Applicant: Martin Zeithaml, Chrudim (CZ)

(72) Inventor: Martin Zeithaml, Chrudim (CZ)

(73) Assignee: CA, INC., Islandia, NY (US)

(21) Appl. No.: 14/262,941

(22) Filed: Apr. 28, 2014

(51) Int. Cl. G06Q 10/10

(52) U.S. Cl. CPC G06Q 10/107

(57) ABSTRACT

A method includes receiving a request to send a voting message to a plurality of voters. The voting message includes a plurality of ballot options. The method also includes generating a first folder corresponding to a first ballot option and determining a rule for organizing a plurality of voting message responses based on a corresponding selected ballot option in each voting message response. The selected ballot option corresponds to one of the plurality of ballot options. The method further includes receiving a first voting message response. The selected ballot option in the first voting message response corresponds to the first ballot option. The method additionally includes determining whether the first voting message response should be filtered into the first folder based on the rule, and, in response to determining that the voting message should be filtered into the first folder, filtering the first voting message response into the first folder.

### BACKGROUND

The disclosure relates generally to email management, and more specifically, to managing voting emails.

### SUMMARY

According to one embodiment of the disclosure, a method includes receiving, at an email server, a request to send a voting message to a plurality of voters. The voting message includes a plurality of ballot options. The method also includes, in response to receiving the request at the email server, generating a first folder corresponding to a first ballot option and determining a rule for organizing a plurality of voting message responses based on a corresponding selected ballot option in each voting message response. The selected ballot option corresponds to one of the plurality of ballot options. The method further includes receiving a first voting message response. The selected ballot option in the first voting message response corresponds to the first ballot option. The method additionally includes determining whether the first voting message response should be filtered into the first folder based on the rule, and, in response to determining that the voting message should be filtered into the first folder, filtering the first voting message response into the first folder.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of a system for managing voting emails in accordance with a particular non-limiting embodiment of the present disclosure.

FIG. 2 illustrates a flow chart of a method for managing voting emails in accordance with a non-limiting embodiment of the present disclosure.

FIG. 3 illustrates a sequence diagram of a system for managing voting emails in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Email applications often include features that enable users to collaborate with and engage other users with email message voting polls. For example, certain email applications include voting buttons that may be placed in an email message. The voting buttons may have several default configurations. The voting buttons may also be fully customizable.

For example, a user may create a new email message and insert voting buttons into the body of the email message using a built-in command, function, or tool. The user may be able to select from a variety of default configurations. One such default configuration may be the Yes/No button configuration. Another default configuration may be the Yes/No/Maybe configuration. Yet another default configuration may be the Approve/Deny configuration. The user may select one of these configurations, and a corresponding widget for receiving voting input may be placed in the message body.

As another example, the user may create a new email message and insert a custom button configuration into the body of the email message. A custom button configuration may enable a user to create their own custom voting button names. For example, co-workers may be asked to weigh effectiveness of a new management strategy. A custom voting button configuration may be created for this survey. For example, custom voting buttons may be named “highly effective”, “mildly effective”, and “ineffective”. The user may create this custom voting button arrangement, and a corresponding widget for receiving voting input may be placed in the message body.

The user may then send the voting message to various desired recipients. The voting message recipients may make a selection using the voting buttons in the voting message. In certain embodiments, the voting buttons may appear when the user clicks on a banner at the top of the email message. For example, a banner may appear in a voting email message that indicates that the sender has requested that the user vote on something. The recipient may be prompted to click on the banner. Voting buttons may appear after the user clicks on the banner. The recipient may then click on a voting button to indicate a selection. The selection may indicate the user's vote.

In certain embodiments, a response may be automatically sent to the sender. The response may indicate the recipient's vote. In certain embodiments, an editable message may be generated that is addressed to the sender. The editable message may be edited by the recipient before being sent to the sender.

A response may be manually sent to the user and/or sender. The response may indicate the vote of the recipient. In certain embodiments, a large number of responses may be received by the user. The user may want to filter such responses into a special folder, or set of folders. The user may further want to create distribution lists for follow-on messages, votes, or record keeping purposes.

The teachings of the present disclosure may enable management of voting email responses by automating management tasks based on message details.

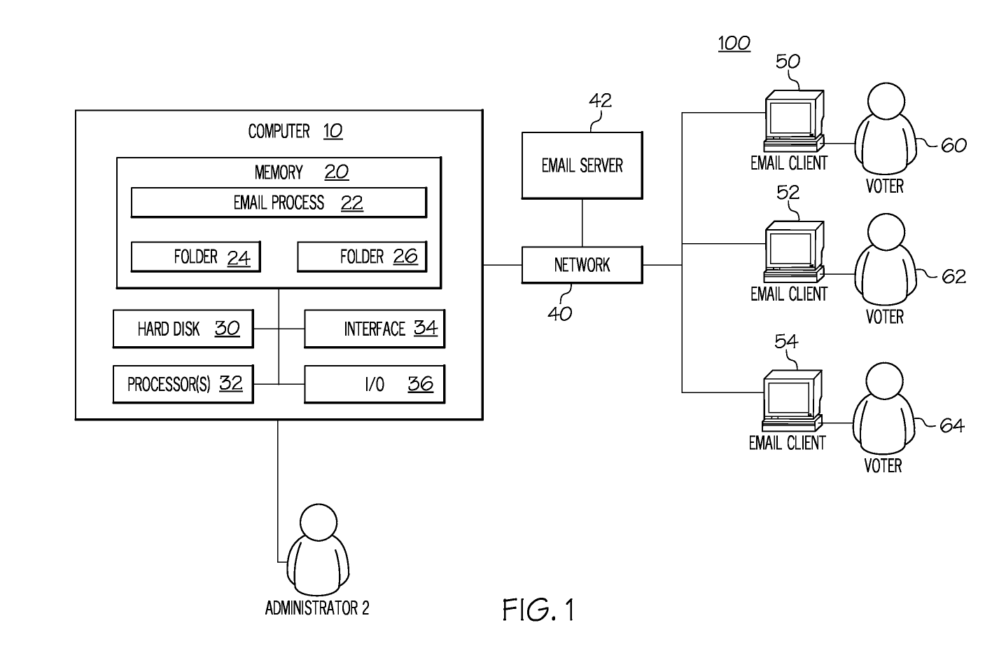

With reference to FIG. 1, a system 100 for managing voting emails is illustrated in accordance with a particular non-limiting embodiment of the present disclosure. System 100 includes computer 10, email server 42, network 40, and email clients 50, 52, and 54. Computer 10 includes memory 20, hard disk 30, processor(s) 32, interface 34, and input/output 36. Memory 20 includes email process 22, and folders 24 and 26. In certain embodiments, administrator 2 creates a voting message using email process 22 on computer 10. Email process 22 may be an email client. Administrator 2 creates a voting message and sends it to a number of voting participants (i.e., voters 60-64). The voting message contains one or more ballot options (i.e., voting buttons). In certain embodiments, email process 22 creates one or more rules for organizing responses to the voting email message. In certain embodiments, email process 22 creates one or more folders (e.g., folders 24 and 26). Each folder may correspond to one or more ballot option. Email process 22 sends the voting message to email server 42 using network 40. Email server 42 sends the voting message to an email client. For example, voter 60 receives the voting message using email client 50. Voter 60 selects a ballot option (i.e., voting button) and responds to the voting message. The response is transmitted from, for example, email client 50, to email server 42 using network 40. Email server 42 transmits the response to email process 22 on computer 10. In certain embodiments, email process 22 filters the response according to the predetermined rule. The response may be organized by being moved into a folder, such as folder 24 and/or folder 26. In certain embodiments a distribution list may be generated based on the contents of folders 24 and/or 26. The distribution list may be generated automatically in response to administrator 2's selection.

In certain embodiments, a ballot option includes a voting button and any other graphical user interface representation of a voting vehicle. A voting message includes any message that may include a request to participate in a vote. A voting message response includes any message that encapsulates a vote that is sent in response to a voting message.

In certain embodiments, the teachings of the present disclosure may primarily be implemented in an email client application. For example, creation of folder structures and generation of rules may take place on a client computer. The client computer may execute an email client that may contain code that, when executed, may create folders and generate rules for filtering voting email responses. Distribution lists may further be automatically generated at an email client.

In certain embodiments, the teachings of the present disclosure may be implemented in a webmail client. For example, an internet based mail client may interact with a server to implement the teachings described herein. Text-based mail clients may also be used to implement the teachings of the present disclosure.

In certain embodiments, the teachings of the present disclosure may primarily be implemented in an email server, such as email server 42 or the like. For example, creation of folder structures and similar processes to those discussed above with respect to an email client may take place on an email server. The email server may contain code that, when executed, may perform the processes specified in the teachings of the present disclosure.

In certain embodiments, system 100 may be implemented using a single email server 42. For example, when administrator 2 and voters 60-64 use the same email server to receive their mail, a single email server may be used. As another example, when administrator 2 and voters 60-64 use separate email server to receive mail, email server 42 may transmit the voting message to a separate email server for distribution to email clients 50-54. Similarly, when a response is sent from email clients 50-54 to computer 10, a second email server may be used. The second email server may transmit the voting message response to email server 42.

In certain embodiments, the teachings of the present disclosure may automate processes used in the management of voting and/or polling emails. For example, folder creation may be automated. Each folder may correspond to a particular voting email. The folder may be further divided into sub-folders that may contain responses. Responses may be sorted among the sub-folders based on the type of response received.

For example, administrator 2 may create a voting email message using email process 22. Administrator 2 may send the voting email message to a number of recipients. Email process 22 may automatically create folders and subfolders based on ballot options in the voting email message. Ballot options may correspond to voting buttons and/or voting options available in the voting message.

In certain embodiments, filtering rules may be automatically created. The filtering rules may route responses into the appropriate folders. For example, when each vote response is received by the email client, a rule may filter each response into an appropriate folder.

The filtering rules may be automatically created when administrator 2, or the like, sends a voting email message. For example, filtering rules may be generated based on ballot options. The filtering rules may route voting message responses to an appropriate email folder. The appropriate email folder may be created by the same process. In certain embodiments, the appropriate email folder may be an existing folder. In certain embodiments, the user may specify which folder to route voting message responses to.

In certain embodiments, distribution lists may be automatically generated based on the voting message responses received. For example, employees may participate in a group vote using an email voting tool. The ballot options included in the voting email may include a choice A and a choice B. Employees may use an email client to submit responses to the voting email by selecting either choice A or choice B. The response may be transmitted to the email voting tool. The responses may be filtered into folders based on a rule. For example, a folder may be generated entitled “Choice A Votes.” As another example, a folder may be generated entitled “Choice B Votes.” A rule may be generated that filters all voting responses into the appropriate folder based on the selected ballot option. The rule and folders may be automatically generated by sending the voting email. A distribution list may be generated to send messages to users based on how each user responded. For example, employees that selected choice A may be added to one distribution list. Employees that selected choice B may be added to a second distribution list.

The distribution lists may be automatically generated. For example, distribution lists may be generated when a user submits a request to the email client to follow-up with voters who voted in a particular way. For example, a user may wish to ask a follow up voting question to voters who selected choice A in the above example.

The distribution list may be generated by scanning each folder for responses. For example, email process 22 may scan folder 24 that corresponds to choice A in the above example. The scan may return a set of voting email responses. The email addresses of each voter that sent a voting email response from the set of voting email responses may be determined. Each email address may be added to the distribution list. An email may be automatically generated. The “to” line of the email may be automatically filled in with the list of email addresses from the distribution list.

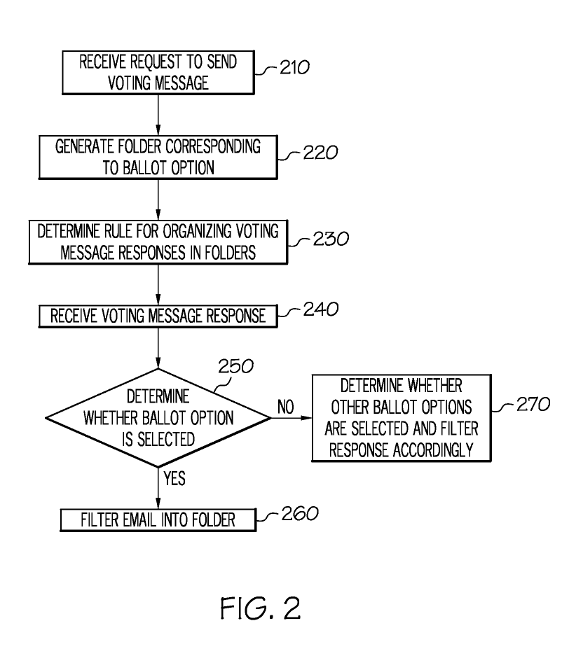

With reference to FIG. 2, a method 200 for managing voting emails is illustrated in accordance with a particular non-limiting embodiment of the present disclosure. At step 210, a request to send a voting message is received. For example, a user may click send on an email message that contains voting functionality. The email client and/or an email server may receive the request to send a voting message.

At step 220, folders are generated that correspond to ballot options in the voting email. A process may parse the voting email to determine various ballot options. For example, a voting email that contains ballot options for “approve” and “deny” may be scanned. The process may detect the presence of ballot options in the message. A folder may be generated for each ballot option. For example, a folder may be generated for responses where the “approve” ballot option was selected. A folder may also be generated for responses where the “deny” ballot option was selected.

In certain embodiments sub-folders may be generated. For example a folder may be generated and named according to the voting message subject. The folder name may also include pertinent information such as the date the message was sent and the name of the user that sent the message. Sub-folder may be generated within this folder. The sub-folders may correspond to the ballot options. Voting responses may be filtered into each sub-folder as described above with regards to folders.

At step 230, a rule for organizing voting message responses is determined. An email client may have an interface for the input of filter rules. The filter rules may be applied to received emails in order to organize emails into folders. The filter rules may be code-based. A process may determine the code required to filter the voting email responses according to the ballot selections present in each voting email.

In certain embodiments, the voting message is sent to a number of users. The users may interact with the voting message and select a ballot option. The users may send a response indicating their ballot option selection.

At step 240, a voting message response is received. At step 250, a determination is made as to what ballot option is selected in the voting message response. This is done in accordance with the generated rule. If a ballot option is selected, the voting message response is filtered into the appropriate folder. If a ballot option is not selected, other rules may be applied to the voting message response for further organization.

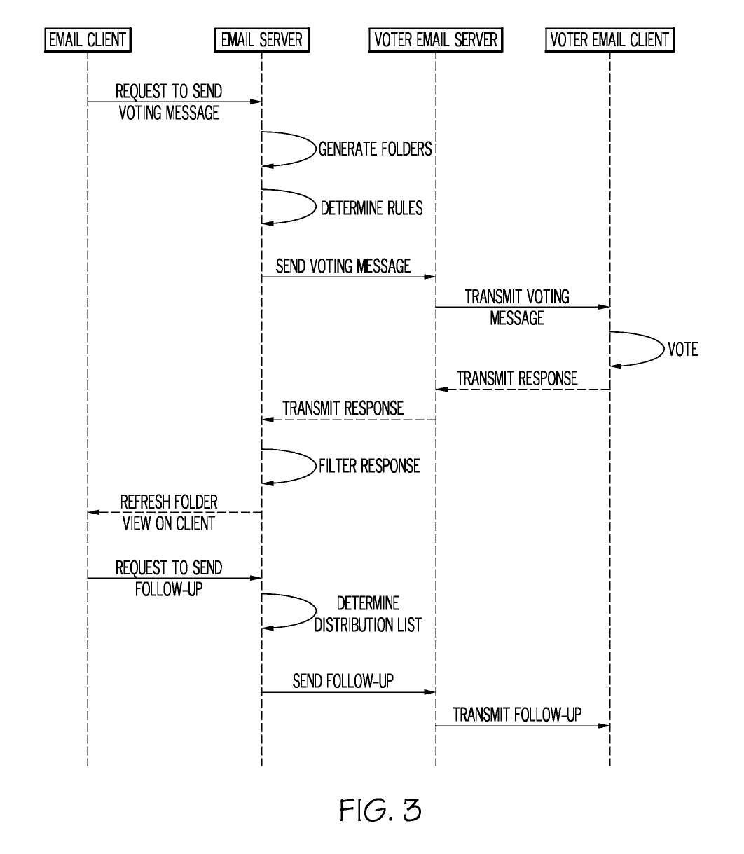

With reference to FIG. 3, a sequence diagram of a system for managing voting emails is illustrated in accordance with a particular embodiment of the present disclosure.

FIG. 3 illustrates the potential email client/server configuration where the voting email is sent to a voter that does not use the same email server as the sender. This is illustrated by separate activity life-lines for the user's email server and the voter's email server. In certain embodiments, such as the one depicted in FIG. 3, folder, rules, and distribution lists may be generated on the sender's email server.

In certain embodiments, rules and folders are created. For example, before sending a voting email to a large number of people, a rule is generated. The rule may filter answers based on the content of the answer. For example, the rule may filter answers based on the vote in the answer. Folders and filtering rules may be created based on the voting options present in the voting email. Such rules, folders, and filters may help to manage answers received in response to the email.

In certain embodiments, a list of senders is generated. For example, when the voting is complete and voting responses are received, a distribution list may be created based on the content of the voting folders. The distribution list may be created based on the email address of each response that was filtered into each respective folder. Thus, a list of people who all voted for the same selection can be ascertained. Such a list can be used in follow-up communications or any other communication.

In certain embodiments, the teachings of the present disclosure may be applicable to a variety of mail user agents (“MUA”) and/or email clients. For example, the teachings of the present disclosure may be applicable to a desktop email client application, such as MICROSOFT OFFICE OUTLOOK®. As another example, the teachings of the present disclosure may be applicable to a web-based email client application (“webmail”), such as GOOGLE GMAIL®.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving, at an email server, a request to send a voting message to a plurality of voters, the voting message comprising a plurality of ballot options;
in response to receiving the request at the email server:
generating a first folder corresponding to a first ballot option of the plurality of ballot options; and
determining a rule for organizing a plurality of voting message responses based on a corresponding selected ballot option in each voting message response, the selected ballot option corresponding to one of the plurality of ballot options;
receiving a first voting message response, wherein the selected ballot option in the first voting message response corresponds to the first ballot option;
determining whether the first voting message response should be filtered into the first folder based on the rule; and
in response to determining that the voting message should be filtered into the first folder, filtering the first voting message response into the first folder.

2. The method of claim 1, further comprising:
receiving the plurality of voting message responses;
determining whether each voting message response should be filtered into the first folder based on the rule; and
determining a distribution list for the first ballot option based on a first set of voting message responses in the first folder, each voting message response in the first set of voting message responses being received from a corresponding voter of the plurality of voters, wherein determining the distribution list comprises determining a respective email address associated with each corresponding voter.

3. The method of claim 2, further comprising:
receiving a second request to send a follow-up message, the second request comprising information indicative of the first ballot option; and
sending the follow-up message to the distribution list for the first ballot option based on the information indicative of the first ballot option.

4. The method of claim 1, further comprising:
generating a second folder corresponding to a second ballot option of the plurality of ballot options;
receiving a second voting message response, wherein the selected ballot option in the second voting message response corresponds to the second ballot option;
in response to receiving the second voting message response, determining whether the second voting message response should be filtered into the second folder based on the rule; and
filtering the second voting message response into the second folder.

5. The method of claim 2, further comprising:
generating a second folder corresponding to a second ballot option of the plurality of ballot options;
determining whether each voting message response should be filtered into the second folder based on the rule; and
determining a distribution list for the first ballot option and second ballot option based on the first set of voting message responses in the first folder and a second set of voting message responses in the second folder.

6. The method of claim 1, wherein the first folder is a server side email folder.

7. The method of claim 1, wherein the rule for organizing the plurality of voting message responses is determined at an email client.

8. A computer configured to access a storage device, the computer comprising:
a processor; and
a non-transitory, computer-readable storage medium storing computer-readable instructions that when executed by the processor cause the computer to perform:
receiving, at an email server, a request to send a voting message to a plurality of voters, the voting message comprising a plurality of ballot options;
in response to receiving the request at the email server:
generating a first folder corresponding to a first ballot option of the plurality of ballot options; and
determining a rule for organizing a plurality of voting message responses based on a corresponding selected ballot option in each voting message response, the selected ballot option corresponding to one of the plurality of ballot options;
receiving a first voting message response, wherein the selected ballot option in the first voting message response corresponds to the first ballot option;
determining whether the first voting message response should be filtered into the first folder based on the rule; and
in response to determining that the voting message should be filtered into the first folder, filtering the first voting message response into the first folder.

9. The computer of claim 8, wherein the computer-readable instructions further cause the computer to perform:
receiving the plurality of voting message responses;
determining whether each voting message response should be filtered into the first folder based on the rule; and
determining a distribution list for the first ballot option based on a first set of voting message responses in the first folder, each voting message response in the first set of voting message responses being received from a corresponding voter of the plurality of voters, wherein determining the distribution list comprises determining a respective email address associated with each corresponding voter.

10. The computer of claim 9, wherein the computer-readable instructions further cause the computer to perform:
receiving a second request to send a follow-up message, the second request comprising information indicative of the first ballot option; and
sending the follow-up message to the distribution list for the first ballot option based on the information indicative of the first ballot option.

11. The computer of claim 8, wherein the computer-readable instructions further cause the computer to perform:
generating a second folder corresponding to a second ballot option of the plurality of ballot options;
receiving a second voting message response, wherein the selected ballot option in the second voting message response corresponds to the second ballot option;
in response to receiving the second voting message response, determining whether the second voting message response should be filtered into the second folder based on the rule; and
filtering the second voting message response into the second folder.

12. The computer of claim 9, wherein the computer-readable instructions further cause the computer to perform:
generating a second folder corresponding to a second ballot option of the plurality of ballot options;
determining whether each voting message response should be filtered into the second folder based on the rule; and
determining a distribution list for the first ballot option and second ballot option based on the first set of voting message responses in the first folder and a second set of voting message responses in the second folder.

13. The computer of claim 8, wherein the first folder is a server side email folder.

14. The computer of claim 8, wherein the rule for organizing the plurality of voting message responses is determined at an email client.

15. A computer program product comprising:
a computer-readable storage medium having computer-readable program code embodied therewith, the computer-readable program code comprising:
computer-readable program code configured to receive, at an email server, a request to send a voting message to a plurality of voters, the voting message comprising a plurality of ballot options;
computer-readable program code configured to, in response to receiving the request at the email server:
generate a first folder corresponding to a first ballot option of the plurality of ballot options; and
determine a rule for organizing a plurality of voting message responses based on a corresponding selected ballot option in each voting message response, the selected ballot option corresponding to one of the plurality of ballot options;
computer-readable program code configured to receive a first voting message response, wherein the selected ballot option in the first voting message response corresponds to the first ballot option;
computer-readable program code configured to determine whether the first voting message response should be filtered into the first folder based on the rule; and
computer-readable program code configured to, in response to determining that the voting message should be filtered into the first folder, filter the first voting message response into the first folder.

16. The computer program product of claim 15, wherein the computer-readable program code further comprises:
computer-readable program code configured to receive the plurality of voting message responses;
computer-readable program code configured to determine whether each voting message response should be filtered into the first folder based on the rule; and
computer-readable program code configured to determine a distribution list for the first ballot option based on a first set of voting message responses in the first folder, each voting message response in the first set of voting message responses being received from a corresponding voter of the plurality of voters, wherein determining the distribution list comprises determining a respective email address associated with each corresponding voter.

17. The computer program product of claim 16, wherein the computer-readable program code further comprises:
computer-readable program code configured to receive a second request to send a follow-up message, the second request comprising information indicative of the first ballot option; and
computer-readable program code configured to send the follow-up message to the distribution list for the first ballot option based on the information indicative of the first ballot option.

18. The computer program product of claim 15, wherein the computer-readable program code further comprises:
computer-readable program code configured to generate a second folder corresponding to a second ballot option of the plurality of ballot options;
computer-readable program code configured to receive a second voting message response, wherein the selected ballot option in the second voting message response corresponds to the second ballot option;
computer-readable program code configured to, in response to receiving the second voting message response, determine whether the second voting message response should be filtered into the second folder based on the rule; and
computer-readable program code configured to filter the second voting message response into the second folder.

19. The computer program product of claim 16, wherein the computer-readable program code further comprises:
computer-readable program code configured to generate a second folder corresponding to a second ballot option of the plurality of ballot options;
computer-readable program code configured to determine whether each voting message response should be filtered into the second folder based on the rule; and
computer-readable program code configured to determine a distribution list for the first ballot option and second ballot option based on the first set of voting message responses in the first folder and a second set of voting message responses in the second folder.

20. The computer program product of claim 15, wherein the first folder is a server side email folder.
